(19) United States
(12) Patent Application Publication
(10) Pub. No.: US 2024/0323007 A1
(43) Pub. Date: Sep. 26, 2024

(54) MEMORY SYSTEM AND DATA ENCRYPTING METHOD

(71) Applicant: Kioxia Corporation, Tokyo (JP)

(72) Inventor: Tadashi NAGAHARA, Minato Tokyo (JP)

(21) Appl. No.: 18/590,716

(22) Filed: Feb. 28, 2024

(30) Foreign Application Priority Data
Mar. 22, 2023 (JP) 2023-045524

(51) Int. Cl. H04L 9/08

(52) U.S. Cl. CPC H04L 9/0866; H04L 9/0869; H04L 9/0891

(57) ABSTRACT

A memory system includes a nonvolatile memory and a controller. The controller is configured to generate an encryption key using health data indicating a deterioration state of the nonvolatile memory and time data, encrypt data with the generated encryption key, and write the encrypted data into the nonvolatile memory. The health data may include a total size of data that has been written into the nonvolatile memory or a total size of data that has been read from the nonvolatile memory.

### CROSS-REFERENCE TO RELATED APPLICATION

This application is based upon and claims the benefit of priority from Japanese Patent Application No. 2023-045524, filed Mar. 22, 2023, the entire contents of which are incorporated herein by reference.

### FIELD

Embodiments described herein relate generally to a memory system and a data encrypting method.

### BACKGROUND

A memory system that encrypts data and stores the encrypted data is provided. The memory system includes a random number generator, generates a key based on a random number, and encrypts data with the key. The random number generator generates a random number in accordance with a rule. In such systems, there is a possibility that a third person detects the regularity of a number string in the key, estimates the key from the regularity, and decrypts the encrypted data.

### BRIEF DESCRIPTION OF THE DRAWINGS

FIG. 1 is a block diagram illustrating an example of an information processing system including a memory system according to a first embodiment;

FIG. 2 is a flowchart illustrating a summary of a first example of encryption performed in the memory system according to the first embodiment;

FIG. 3 is a diagram illustrating an example of a password table according to the first embodiment;

FIG. 4 is a diagram illustrating an example of a key table according to the first embodiment;

FIG. 5 is a flowchart illustrating a summary of a first example of decryption performed in the memory system according to the first embodiment;

FIG. 6 is a flowchart illustrating a summary of a second example of encryption performed in the memory system according to the first embodiment;

FIG. 7 is a flowchart illustrating a summary of a second example of decryption performed in the memory system according to the first embodiment;

FIG. 8 is a diagram illustrating an example of health data according to the first embodiment;

FIGS. 9A to 9D are diagrams illustrating examples of health data used for key generation according to the first embodiment;

FIGS. 10A and 10B are diagrams illustrating an example of real time clock (RTC) data according to the first embodiment;

FIG. 11 is a diagram illustrating an example of an operation of an RTC according to the first embodiment;

FIG. 12 is a block diagram illustrating a detailed example of an encrypting/decrypting circuit according to the first embodiment;

FIG. 13 is a flowchart illustrating a first half of a detailed example of encryption by the encrypting/decrypting circuit according to the first embodiment;

FIG. 14 is a flowchart illustrating a second half of the detailed example of encryption by the encrypting/decrypting circuit according to the first embodiment;

FIGS. 15A and 15B are diagrams illustrating a first example of key allocation in the memory system according to the first embodiment;

FIGS. 16A and 16B are diagrams illustrating a second example of key allocation in the memory system according to the first embodiment;

FIGS. 17A and 17B are diagrams illustrating a third example of key allocation in the memory system according to the first embodiment;

FIGS. 18A to 18C are diagrams illustrating examples of a key generation timing in the memory system according to the first embodiment;

FIGS. 19A to 19D are diagrams illustrating detailed examples of the key generation timing in the memory system according to the first embodiment;

FIG. 20 is a diagram illustrating an example of a key update table in the memory system according to the first embodiment;

FIGS. 21A to 21C are diagrams illustrating an example of key update in the memory system according to the first embodiment;

FIGS. 22A to 22C are diagrams illustrating an example of key update in the memory system according to the first embodiment;

FIG. 23 is a flowchart illustrating a part of an example of a write operation in the memory system according to the first embodiment;

FIG. 24 is a flowchart illustrating the remaining part of the example of the write operation in the memory system according to the first embodiment;

FIG. 25 is a flowchart illustrating a part of an example of a read operation in the memory system according to the first embodiment; and

FIG. 26 is a flowchart illustrating a part of an example of a patrol read operation in the memory system according to the first embodiment.

### DETAILED DESCRIPTION

Embodiments provide a memory system and a data writing method in which it is difficult for a third person to decrypt encrypted data.

In general, according to an embodiment, a memory system includes a nonvolatile memory and a controller. The controller is configured to generate an encryption key using health data indicating a deterioration state of the nonvolatile memory and time data, encrypt data with the generated encryption key, and write the encrypted data into the nonvolatile memory.

Hereinafter, an embodiment will be described with reference to the drawings. The following description is an example of a device or a method for practicing the technical ideas of the embodiment, and the technical ideas of the embodiment are not intended to limit structures, shapes, arrangement, materials, and the like of components to those described below. Of course, modifications that can be easily conceived by those skilled in the art are provided in the range of the disclosure. In order to clarify the description, in the drawings, the size, thickness, planar dimension, shape, or the like of each of elements may be changed from an actual embodiment and schematically illustrated. A plurality of drawings may also include elements having different dimensional relationships or ratios. In a plurality of drawings, corresponding elements are represented by the same reference numerals, and the repeated description may not be made. Some elements may be represented by a plurality of names. However, these names are merely examples, and the use of other names for the elements is not denied. In addition, the use of other names for elements that are not represented by a plurality of names is also not denied. In the following description, “connection” represents not only direct connection but also connection through another element.

Hereinafter, an embodiment will be described in detail with reference to the drawings.

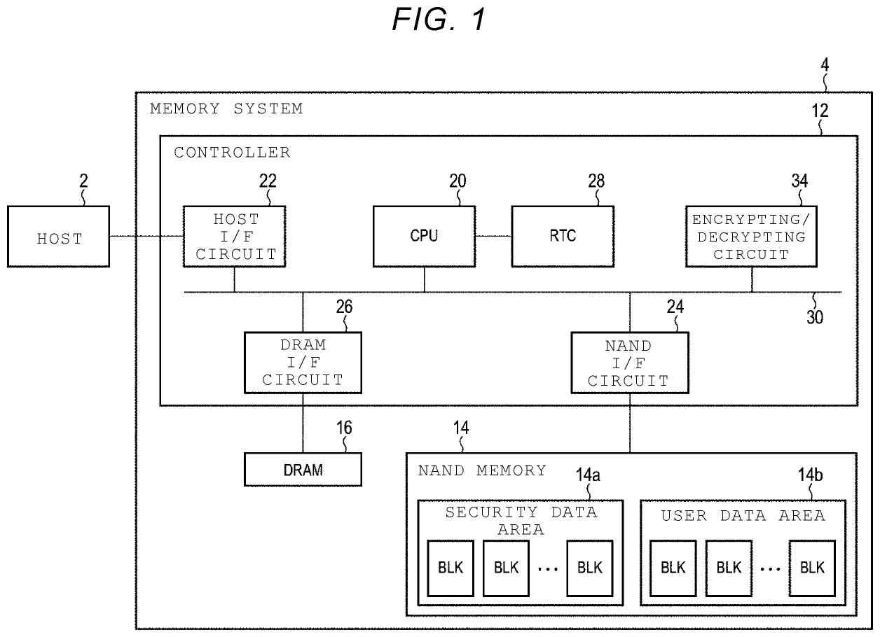

FIG. 1 is a block diagram illustrating an example of an information processing system including a memory system 4 according to a first embodiment. The information processing system includes the memory system 4 and a host 2.

The host 2 is an information processing apparatus as an external apparatus that accesses the memory system 4. The host 2 may be a server (storage server) that stores a large amount of various data in the memory system 4. The host 2 may be a personal computer.

The memory system 4 can be used as a main storage of the host 2. The memory system 4 may be a system for business use that is incorporated into a server of a data center or the like. The memory system 4 may be a system for personal use that is incorporated into a personal computer.

The memory system 4 can be connected to the host 2. The memory system 4 and the host 2 may be provided in the same housing. Alternatively, the memory system 4 and the host 2 may be provided in separate housings, respectively. FIG. 1 illustrates an embodiment where the memory system 4 and the host 2 are provided in separate housings, respectively. In this case, the memory system 4 may be connected to the host 2 through a cable or a network.

The memory system 4 is a storage device configured to write data into a nonvolatile storage medium or to read data from a nonvolatile storage medium. Examples of the memory system 4 include a solid state drive (SSD), an embedded-multi-media-card (eMMC), a universal flash storage (UFS) device, and a memory card. FIG. 1 illustrates an embodiment where the memory system 4 is an SSD.

Examples of the nonvolatile storage medium include a NAND flash memory, a NOR flash memory, a magneto-resistive random access memory (MRAM), a phase change random access memory (PRAM), a resistive random access memory (ReRAM), and a ferroelectric random access memory (FeRAM). FIG. 1 illustrates an embodiment where the example of the nonvolatile storage medium is a NAND flash memory (hereinafter, referred to as “NAND memory”) 14. The memory system 4 includes a controller 12, a NAND memory 14, and a dynamic random access memory (DRAM) 16. In the SSD, the controller 12 and the NAND memory 14 are formed as separate components. In the eMMC, the controller 12 and the NAND memory 14 are formed as the same component.

The controller 12 writes data into the NAND memory 14 in response to a write request transmitted from the host 2. The controller 12 reads data from the NAND memory 14 in response to a read request transmitted from the host 2.

The controller 12 can be configured with a circuit such as a system on a chip (SoC).

The DRAM 16 is an example of a volatile memory. The DRAM 16 is, for example, a DRAM based on a double data rate 3 low voltage (DDR3L) specification. The DRAM 16 operates as a buffer memory that stores data that is supplied from the host 2 to the memory system 4 and is being written into or has not been written into the NAND memory 14 or data that is read from the NAND memory 14 and is being transmitted to or has not been transmitted to the host 2. The DRAM 16 includes an area where an address translation table that defines association between a logical address relating to an address designated by the host 2 and a physical address of the NAND memory 14 is stored, an area where a request received from the host 2 is stored, an area (referred to as “write buffer) where data that is being written into or has not been written into the NAND memory 14 is stored, and an area (referred to as “read buffer”) where data that is read from the NAND memory 14 and is being transmitted to or has not been transmitted to the host 2 is stored.

The DRAM 16 as the volatile memory may be provided in the controller 12 without being provided in the controller 12. As the volatile memory, a static random access memory (SRAM) capable of high-speed access may be used instead of the DRAM 16.

The NAND memory 14 may be configured with a single chip or a plurality of chips. The chip includes a memory cell array including a plurality of memory cells that are located in a matrix. The memory cell array may be a memory cell array having a two-dimensional structure where a plurality of memory cells are located in a plane or may be a memory cell array having a two-dimensional structure where a plurality of memory cells are three-dimensionally located. The memory cell array includes a plurality of blocks BLK. Each of the blocks BLK includes a plurality of pages. The block BLK functions as a minimum unit of erase. Each of the pages includes a plurality of memory cells connected to the same word line. The page is a unit of a data write operation and a data read operation.

The NAND memory 14 includes a security data area 14a and a user data area 14b. The host 2 is accessible to the user data area 14b but is not accessible to the security data area 14a. The controller 12 is accessible to the security data area 14a and the user data area 14b.

The controller 12 includes a CPU 20, a host interface (host I/F) circuit 22, a NAND interface circuit (NAND I/F) 24, a DRAM interface (DRAM I/F) circuit 26, and an encrypting/decrypting circuit 34, and a real-time clock (RTC) 28. The CPU 20, the encrypting/decrypting circuit 34, the host I/F circuit 22, the NAND I/F circuit 24, and the DRAM I/F circuit 26 are connected through a bus line 30.

The host I/F circuit 22 is electrically connected to the host 2, the NAND I/F circuit 24 is electrically connected to the NAND memory 14, and the DRAM I/F circuit 26 is electrically connected to the DRAM 16.

The host I/F circuit 22 is based on a specification such as Small Computer System Interface (SCSI), Serial Attached SCSI (SAS), AT Attachment (ATA), Serial ATA (SATA), PCI Express (PCIe)™, Ethernet™, Fibre channel™, NVM Express™, Universal Serial Bus (USB)™, or Universal Asynchronous Receiver/Transmitter (UART)™.

The NAND I/F circuit 24 is based on a specification such as Toggle Open NAND Flash Interface (ONFI).

The CPU 20 includes, for example, a module that implements various functions by executing firmware stored in the NAND memory 14. Examples of the various functions include an encrypting function and a decrypting function. The CPU 20 includes the encrypting/decrypting circuit 34.

The host 2 transmits user data that is a plaintext to the memory system 4.

The encrypting/decrypting circuit 34 encrypts the user data, and decrypts the encrypted data.

For example, when a write request is received from the host 2 through the host I/F circuit 22, the CPU 20 inputs user data encrypting relating to the write request to the encrypting/decrypting circuit 34. The encrypting/decrypting circuit 34 encrypts the input user data. The CPU 20 causes an error correcting coding (ECC) circuit (not illustrated) to execute ECC on the data encrypted by the encrypting/decrypting circuit 34. The ECC circuit generates a parity for error correction (ECC parity), and generates a code word including the generated ECC parity and the encrypted data. The CPU 20 is configured to write the code word into the NAND memory 14 through the NAND I/F circuit 24. That is, the CPU 20 is configured to write data based on the data encrypted by the encrypting/decrypting circuit 34 into the NAND memory 14 through the NAND I/F circuit 24 in response to a write request from the host 2.

In addition, for example, when a read request is received from the host 2 through the host I/F circuit 22, the CPU 20 reads data based on the read request from the NAND memory 14 through the NAND I/F circuit 24. The CPU 20 causes the ECC circuit to execute an error detection and correction process on the read data. The CPU 20 inputs the read data on which the error detection and correction process is executed to the encrypting/decrypting circuit 34 as the encrypted data. The encrypting/decrypting circuit 34 decrypts the input encrypted data. That is, the CPU 20 is configured to decode data based on the data read from the NAND memory 14 in response to the read request from the host 2 and to transmit the decrypted data to the host 2 through the host I/F circuit 22.

The RTC 28 is an IC that outputs time data (hereinafter, referred to as “RTC data”) indicating year, month, date, and time, and is backed up by a battery. The RTC 28 is connected to the CPU 20 through a serial bus. Examples of the serial bus include an I2C bus and a SPI bus. The RTC 28 transmits the RTC data to the CPU 20.

In the nonvolatile memory such as the NAND memory 14, the memorability deteriorates for each write operation or erase operation. When the number of write operations or the number of erase operations exceeds an upper limit number, the nonvolatile memory cannot properly store data. In the memory system 4, a health status command for checking a deterioration state of the NAND memory 14 is defined such that a measure can be taken before the number of write operations or the number of erase operations in the NAND memory 14 exceeds a condition number. The NAND memory 14 outputs the health data indicating the deterioration state in response to the health status command. An example of the health data is the number of erase operations for each block.

The encrypting/decrypting circuit 34 generates a key based on at least the RTC data and the health data, and executes an encrypting process and a decoding process with the key. Therefore, when the key is generated, the encrypting/decrypting circuit 34 receives the health data output from the NAND memory 14, and receives the RTC data output from the RTC 28. The encrypting/decrypting circuit 34 generates a key based on the RTC data and the health data. The RTC data and the health data changes in a short period of time. Therefore, there is a possibility that the key may be known a to third person. The encrypting/decrypting circuit 34 may generate a key not only based on the RTC data and the health data but also a password set by a user.

FIG. 1 illustrates an example where the encrypting/decrypting circuit 34 is implemented by hardware. The encrypting/decrypting circuit 34 may be implemented by firmware or may be implemented by a combination of hardware and firmware.

The controller 12 may include an encrypting circuit instead of including the encrypting/decrypting circuit 34. In this case, the CPU 20 is configured to transmit data based on the data read from the NAND memory 14 through the NAND I/F circuit 24 in response to the read request from the host 2 to the host 2 through the host I/F circuit 22 as it is without decoding the data. The host 2 decrypts the data.

Next, two examples of the encrypting/decrypting processing will be described. A first example is an example where a password is required. A second example is an example where the decoding process is executed by the host 2 without requiring a password.

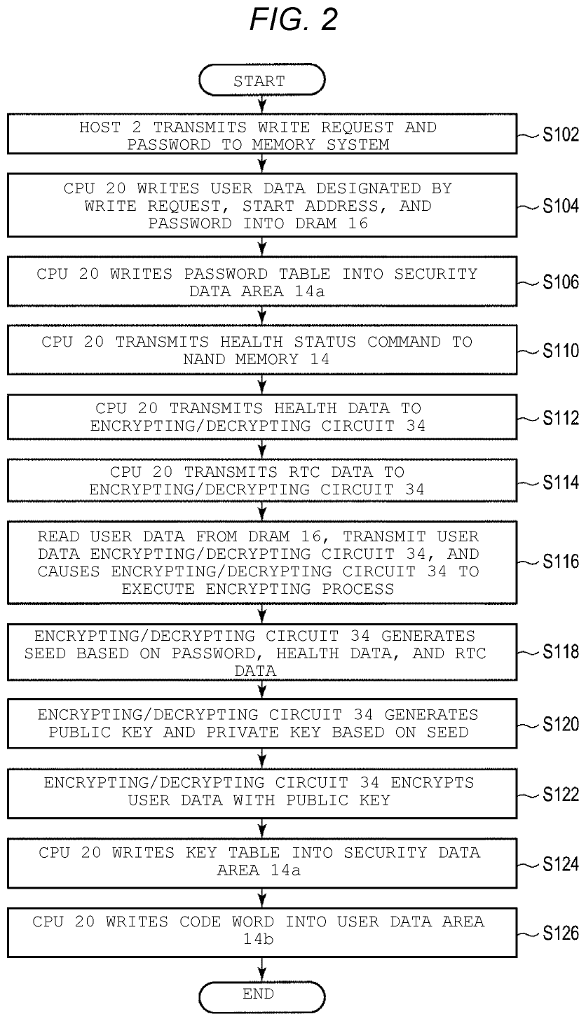

FIG. 2 is a flowchart illustrating the summary of the first example of a write process into the memory system 4 according to the first embodiment.

A user of the host 2 determines a password for the user data to be written into the memory system 4, and inputs the password to the host 2.

The host 2 transmits a write request and the password to the memory system 4 (S102). The write request includes write target user data and a start address (logical address). The start address is an address where the user data starts to be written.

When the CPU 20 receives the write request and the password through the host I/F circuit 22, the CPU 20 writes the user data designated by the write request, the start address, and the password into the DRAM 16 through the DRAM I/F circuit 26 (S104).

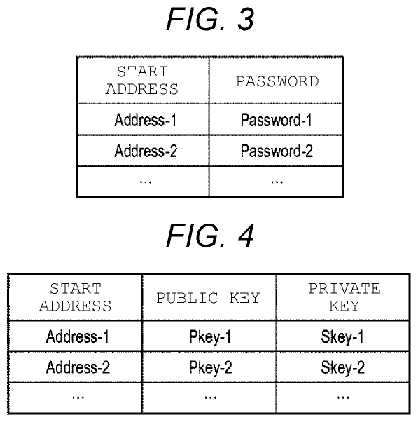

The CPU 20 writes a password table indicating a relationship between the start address and the password into the security data area 14a of the NAND memory 14 through the NAND I/F circuit 24 (S106). FIG. 3 is a diagram illustrating an example of the password table according to the first embodiment. The password table shows that a password Password-1 is set to data where the start address is an address Address-1 and that a password Password-2 is set to data where the start address is an address Address-2.

The CPU 20 transmits a health status command to the NAND memory 14 through the NAND I/F circuit 24 (S110). When the health status command is received, the NAND memory 14 transmits health data back to the CPU 20 through the NAND I/F circuit 24.

The CPU 20 transmits the health data to the encrypting/decrypting circuit 34 (S112).

The CPU 20 transmits the RTC data output from the RTC 28 to the encrypting/decrypting circuit 34 (S114).

The CPU 20 may execute the transmission (S114) of the RTC data before the transmission (S110) of the health status command.

The CPU 20 reads user data from the DRAM 16 through the DRAM I/F circuit 26, transmits the user data to the encrypting/decrypting circuit 34, and causes the encrypting/decrypting circuit 34 to execute the encrypting process (S116).

The encrypting/decrypting circuit 34 generates a key in accordance with a key generation algorithm. An example of the key generation algorithm is an RSA algorithm. The encrypting/decrypting circuit 34 generates a seed based on the password, the health data, and the RTC data (S118).

The encrypting/decrypting circuit 34 generates a public key and a private key based on the seed (S120). The public key is used for encrypting. The private key is used for decoding.

The encrypting/decrypting circuit 34 encrypts the user data with the public key (S122).

The CPU 20 reads a start address relating to the encrypted data from the DRAM 16, and writes a key table indicating a relationship between the start address and the public key and the private key into the security data area 14a of the NAND memory 14 through the NAND I/F circuit 24 (S124). FIG. 4 is a diagram illustrating an example of the key table according to the first embodiment. The key table shows that a public key PKey-1 and a private key Skey-1 are allocated to data where the start address is an address Address-1, and that a public key PKey-2 and a private key Skey-2 are allocated to data where the start address is an address Address-2. The host 2 cannot access the security data area 14a. Therefore, the host 2 cannot read the private key, and the private key is more securely protected.

The CPU 20 may execute the encrypting operation (S122) and the write operation (S124) of the key table in the reverse order.

The CPU 20 causes the ECC circuit (not illustrated) to execute ECC on the data encrypted by the encrypting/decrypting circuit 34, and writes a code word including the ECC parity and the encrypted data into the start address of the user data area 14b of the NAND memory 14 through the NAND I/F circuit 24 (S126).

The CPU 20 may execute the write operation (S124) of the key table and the write operation (S126) of the code word in the reverse order.

After the write operation (S126) of the code word, the write process ends.

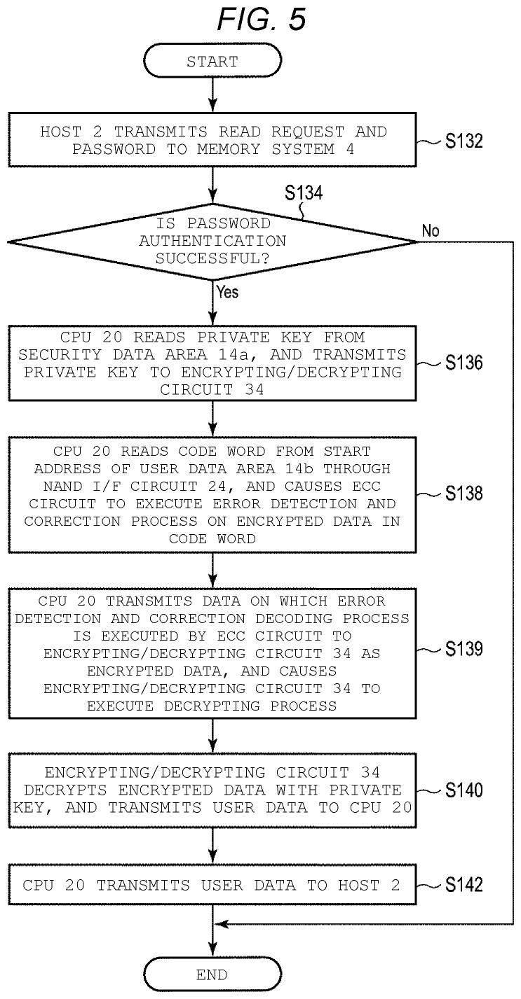

FIG. 5 is a flowchart illustrating the summary of a first example of a read process into the memory system 4 according to the first embodiment.

The user of the host 2 inputs a password of read target user data to the host 2.

The host 2 transmits a read request and the password to the memory system 4 (S132). The read request includes a start address (logical address) and a data size. The start address is an address where the code word starts to be read.

When the CPU 20 receives the read request and the password through the host I/F circuit 22, the CPU 20 reads a password corresponding to the start address from the password table stored in the security data area 14a through the NAND I/F circuit 24. The CPU 20 compares the password transmitted from the host 2 and the password read from the security data area 14a to each other to execute password authentication, and determines whether the password authentication is successful (S134).

When both of the passwords do not match with each other, that is, the password authentication fails (No in S134), the CPU 20 ends the read process.

When both of the passwords match with each other, that is, the password authentication is successful (Yes in S134), the CPU 20 reads a private key corresponding to the start address from the key table stored in the security data area 14a through the NAND I/F circuit 24, and transmits the private key to the encrypting/decrypting circuit 34 (S136).

The CPU 20 reads the code word from the start address of the user data area 14b through the NAND I/F circuit 24, and causes the ECC circuit to execute an error detection and correction process on the encrypted data in the code word (S138). The CPU 20 transmits the data on which the error detection and correction process is executed by the ECC circuit to the encrypting/decrypting circuit 34 as the encrypted data, and executes the encrypting/decrypting circuit 34 to execute a decoding process (S139).

The encrypting/decrypting circuit 34 decrypts the encrypted data with the private key, and transmits the user data obtained by decoding to the CPU 20 (S140).

The CPU 20 transmits the user data to the host 2 through the host I/F circuit 22 (S142).

After the transmission of the user data (S142), the read process ends.

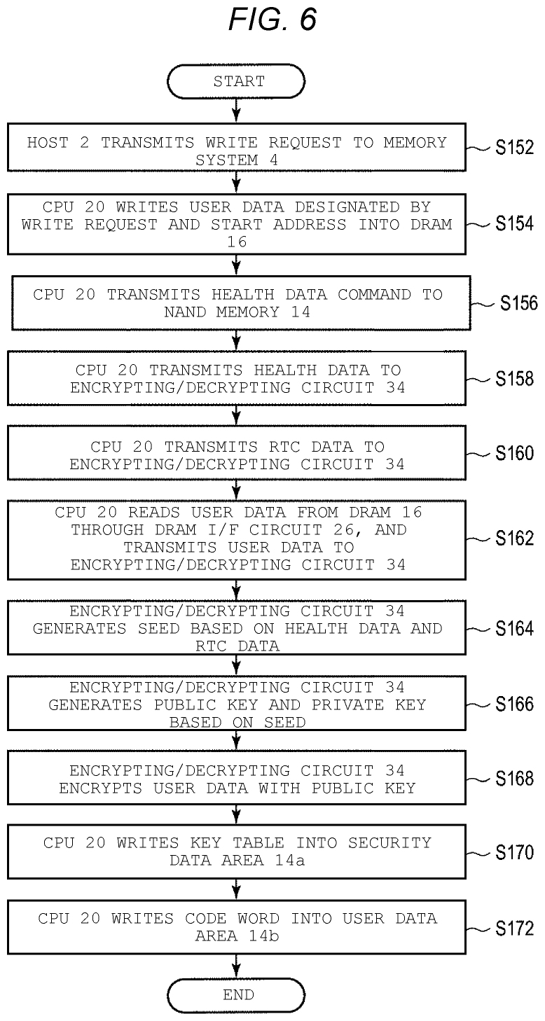

FIG. 6 is a flowchart illustrating the summary of a second example of a write process into the memory system 4 according to the first embodiment.

The host 2 transmits the write request to the memory system 4 (S152).

When the CPU 20 receives the write request through the host I/F circuit 22, the CPU 20 writes the user data designated by the write request and the start address into the DRAM 16 through the DRAM I/F circuit 26 (S154).

The CPU 20 transmits not only a storage address but also a read command to the NAND memory 14 through the NAND I/F circuit 24 to read health data (S156). When the command is received, the NAND memory 14 transmits health data back to the CPU 20 through the NAND I/F circuit 24.

The CPU 20 transmits the health data to the encrypting/decrypting circuit 34 (S158).

The CPU 20 transmits the RTC data output from the RTC 28 to the encrypting/decrypting circuit 34 (S160). The CPU 20 may execute the transmission (S160) of the RTC data before the transmission (S156) of the health status command.

The CPU 20 reads user data from the DRAM 16 through the DRAM I/F circuit 26, and transmits the user data to the encrypting/decrypting circuit 34 (S162). The encrypting/decrypting circuit 34 generates a seed based on the health data and the RTC data (S164).

The encrypting/decrypting circuit 34 generates a key based on the seed. When the key generation algorithm is an RSA algorithm, the encrypting/decrypting circuit 34 generates a public key and a private key based on the seed (S166).

The encrypting/decrypting circuit 34 encrypts the user data with the private key or the public key (S168).

The CPU 20 reads a start address relating to the encrypted data from the DRAM 16, and writes the key table (FIG. 4) into the security data area 14a of the NAND memory 14 through the NAND I/F circuit 24 (S170).

The CPU 20 may execute the write operation (S170) of the key table before the transmission (S162) of the user data.

The CPU 20 causes the ECC circuit (not illustrated) to execute ECC on the data encrypted by the encrypting/decrypting circuit 34, and writes a code word including the ECC parity and the encrypted data into the start address of the user data area 14b of the NAND memory 14 through the NAND I/F circuit 24 (S172).

The CPU 20 may execute the write operation (S170) of the key table and the write operation (S172) of the code word in the reverse order.

After the write operation (S172) of the code word, the write process ends.

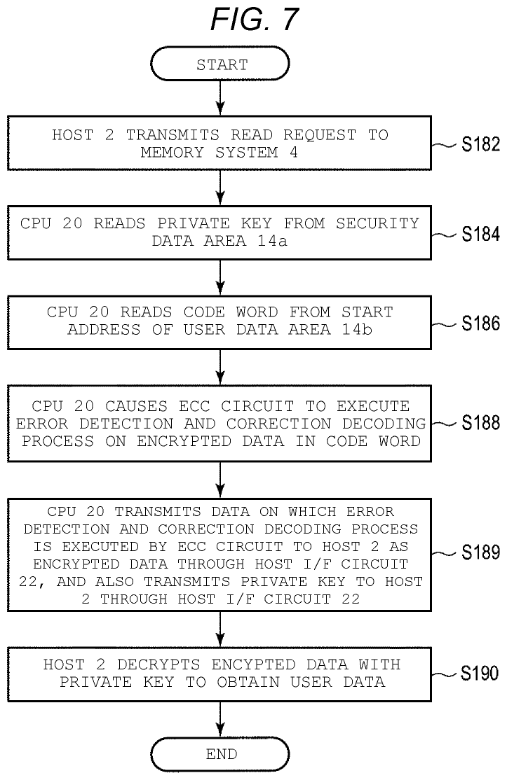

FIG. 7 is a flowchart illustrating the summary of a second example of the read process into the memory system 4 according to the first embodiment.

The host 2 transmits the read request to the memory system 4 (S182).

When the CPU 20 receives the read request through the host I/F circuit 22, the CPU 20 reads a private key corresponding to the start address from the key table stored in the security data area 14a through the NAND I/F circuit 24 (S184).

The CPU 20 reads the code word from the start address of the user data area 14b through the NAND I/F circuit 24 (S186).

The CPU 20 may execute the read operation (S184) of the private key and the read operation (S186) of the code word in the reverse order.

The CPU 20 causes the ECC circuit to execute an error detection and correction process on the encrypted data in the code word (S188). The CPU 20 transmits the data on which the error detection and correction process is executed by the ECC circuit to the host 2 as the encrypted data through the host I/F circuit 22, and also transmits the private key to the host 2 through the host I/F circuit 22 (S189).

The host 2 decrypts the encrypted data with the private key to obtain user data (S190). Next, the read process ends.

In the first example of the write/read process, the memory system 4 decrypts data, only the host 2 used by the user who passes the password authentication can read the data, and a third person who does not know the password cannot read the data. When the data processing performance of the memory system 4 is lower than the data processing performance of the host 2, the latency of the read operation may be higher than that of the second example described below.

In the second example of the write/read process, the host 2 decrypts data. Therefore, the latency of the read operation is not higher than that of the first example. However, all the users who access the host 2 can know the private key, and there is a possibility that the confidentiality of data is poorer than that of the first example.

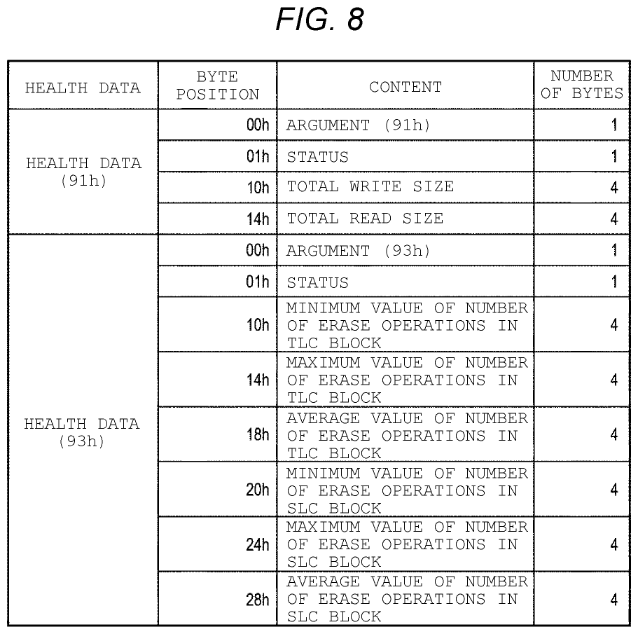

The health data will be described. FIG. 8 is a diagram illustrating an example of the health data according to the first embodiment. Examples of the health data include health data of e-MMC and a health status command. The CPU 20 transmits a read command to the NAND memory 14 where health data is stored to read health data based on a health status command including an argument. In the health status command, any one of a plurality of values, for examples, two values including 91h and 93h can be set to the argument. The NAND memory 14 transmits the health data (91h) back to the CPU 20 according to the read command that is set by the CPU 20 according to the argument. The health data (91h) is data of 10 bytes. Data of 1 byte from a byte position 00h indicates the argument (91h) of the health status command. Data of 1 byte from a byte position 01h indicates the status. The status indicates whether the read operation of the health status command is successful or fails. Data of 4 bytes from a byte position 10h indicates the total amount (total write size) of data written in the NAND memory 14. Data of 4 bytes from a byte position 14h indicates the total amount (total read size) of data read from the NAND memory 14.

The NAND memory 14 transmits the health data (93h) back to the CPU 20 according to the read command that is set by the CPU 20 based on the health status command where the argument is 93h. The health data (93h) is data of 26 bytes. Data of 1 byte from a byte position 00h indicates the argument (93h) of the health status command. Data of 1 byte from a byte position 01h indicates the status. Data of 4 bytes from a byte position 10h indicates a minimum value of the number of erase operations in each of blocks of a first type. Data of 4 bytes from a byte position 14h indicates a maximum value of the number of erase operations in each of blocks of the first type. Data of 4 bytes from a byte position 18h indicates an average value of the number of erase operations in each of blocks of the first type. Data of 4 bytes from a byte position 20h indicates a minimum value of the number of erase operations in each of blocks of a second type. Data of 4 bytes from a byte position 24h indicates a maximum value of the number of erase operations in each of blocks of the second type. Data of 4 bytes from a byte position 28h indicates an average value of the number of erase operations in each of blocks of the second type.

The memory cells include memory cells where data of 1 bit is stored per cell and memory cells where data of a plurality of bits are stored per cell. The blocks include blocks of plural types corresponding to the number of bits in data stored per cell. The blocks include single-level cell (SLC) blocks that store data of 1 bit per cell and blocks that can store data of a plurality of bits per cell. The blocks that can store data of a plurality of bits per cell include a multi-level cell (MLC) block that can store data of two bits per cell, a plurality of triple-level cell (TLC) blocks that can store data of three bits per cell, and a quad-level cell (QLC) block that can store data of 4 bits per cell. The example of the health data (93) of FIG. 8 is an example where the blocks of the NAND memory 14 include SLC blocks and TLC blocks. The example of the block of the first type is the TLC block, and the example of the block of the second type is the SLC block.

When the memory system 4 is an SSD, the controller 12 is configured as a separate package from the NAND memory 14. When the memory system 4 is an eMMC, the controller 12 is configured as the same package as the NAND memory 14. In the SSD or the eMMC, a part of the TLC blocks can be used as the SLC blocks. A part of the TLC block used as the SLC blocks will be referred to as pSLC blocks. In the eMMC, the health data (93h) includes a minimum value, a maximum value, and an average value of the number of erase operations in each of the pSLC blocks instead of the minimum value, the maximum value, and the average value of the number of erase operations in each of the SLC blocks.

At least one of the health data (91h) and the health data (93h) is used for generating a public key and a private key.

FIGS. 9A, 9B, 9C, and 9D are diagrams illustrating examples of health data used for key generation according to the first embodiment. Hereinafter, the key generation refers to generation of a public key and a private key. The CPU 20 generates keys based on health data of 36 bytes (0×24) configured with the health data (91h) and the health data (93h). Data of 10 bytes from byte positions 00h, 01h, and 10h-17h of the health data (91h) is data of 10 bytes from a byte position 0-9 of health data of 36 bytes for key generation. Data of 26 bytes from byte positions 00h, 01h, 10h-1Bh, and 20h-2Bh of the health data (93h) is data of 26 bytes from a byte position A-23 of health data of 36 bytes for key generation. Health data 91-0×00 of FIGS. 9A to 9D indicates data from a byte position 00h of the health data (91h). Health data 93-0×00 of FIGS. 9A to 9D indicates data from a byte position 00h of the health data (93h).

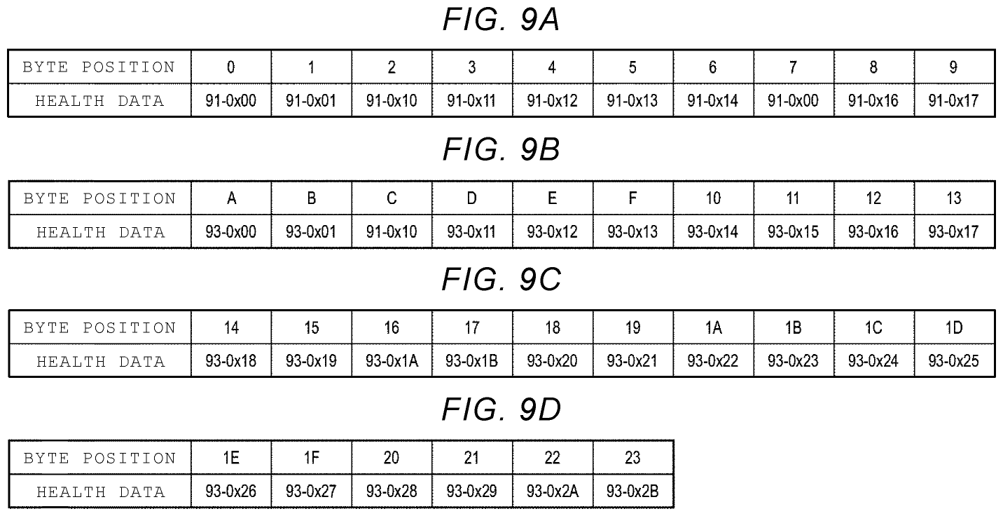

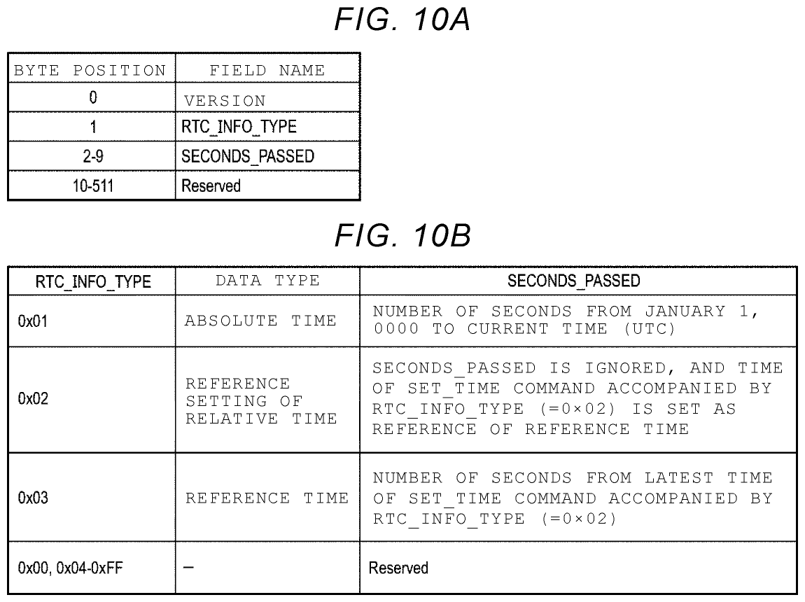

The RTC data will be described. FIGS. 10A and 10B are diagrams illustrating an example of the RTC data according to the first embodiment. FIG. 10A illustrates an example of a data format of the RTC data. The example of the RTC data illustrated in FIG. 10 is data of 512 bytes. Data of 1 byte from a byte position 0 indicates the version. Data of 1 byte from a byte position 1 indicates RTC_INFO_TYPE. Data r7-r0 of 8 bytes from a byte position 2-9 indicates SECONDS_PASSED (the number of seconds elapsed). Data of 502 bytes from a byte position 10-511 is Reserved.

The encrypting/decrypting circuit 34 uses SECONDS_PASSED for generating keys. SECONDS_PASSED can adopt data of plural types. RTC_INFO_TYPE designates the data type of SECONDS_PASSED.

FIG. 10B illustrates an example of a relationship between RTC_INFO_TYPE and the data type of SECONDS_PASSED.

When RTC_INFO_TYPE is 0×01, the data type is an absolute time, and SECONDS_PASSED indicates the number of seconds from a predetermined time such as January 1, 0 to the current UTC time.

When RTC_INFO_TYPE is 0×02, the data type is reference setting of a relative time, SECONDS_PASSED is ignored, and a transmission time of a SET TIME command accompanied by RTC_INFO_TYPE (0×02) is set as a reference of the relative time.

When RTC_INFO_TYPE is 0×03, the data type is a relative time, and SECONDS_PASSED indicates the number of seconds elapsed from the time of a latest SET TIME command accompanied by RTC_INFO_TYPE (0×02).

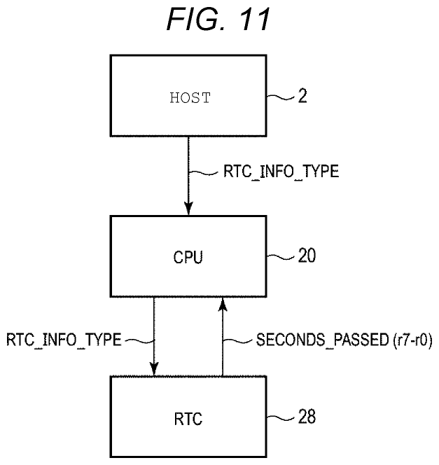

FIG. 11 is a diagram illustrating an example of an operation of the RTC 28 according to the first embodiment. The user of the host 2 designates RTC_INFO_TYPE. The host 2 transmits RTC_INFO_TYPE to the memory system 4 before executing the encrypting/decrypting operation. When RTC_INFO_TYPE is received, the CPU 20 transmits RTC_INFO_TYPE to the RTC 28. The RTC 28 transmits SECONDS_PASSED of the type designated by RTC_INFO_TYPE back to the CPU 20. For example, when RTC_INFO_TYPE is 0×01, the RTC 28 transmits the absolute time, for example, SECONDS_PASSED (r7-r0) indicating “00 00 00 0E D7 60 B9 23” (hexadecimal number) back to the CPU 20. Here, r7=00, r6=00, r5=00, r4=0E, r3=D7, r2=60, r1=B9, and r0=23.

An example of the encrypting/decrypting operation by the encrypting/decrypting circuit 34 will be described.

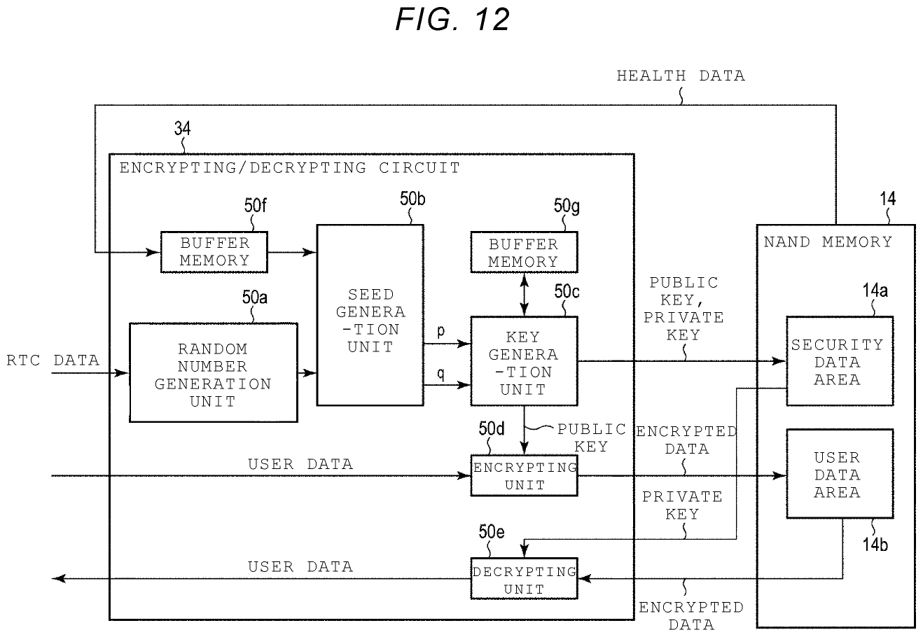

FIG. 12 is a block diagram illustrating a detailed example of the encrypting/decrypting circuit 34 according to the first embodiment. The encrypting/decrypting circuit 34 includes a random number generation unit 50a, a seed generation unit 50b, a key generation unit 50c, an encrypting unit 50d, a decoding unit 50e, and buffer memories 50f and 50g. The seed generation unit 50b and the key generation unit 50c generate a public key and a private key in accordance with one algorithm, here, an RSA algorithm.

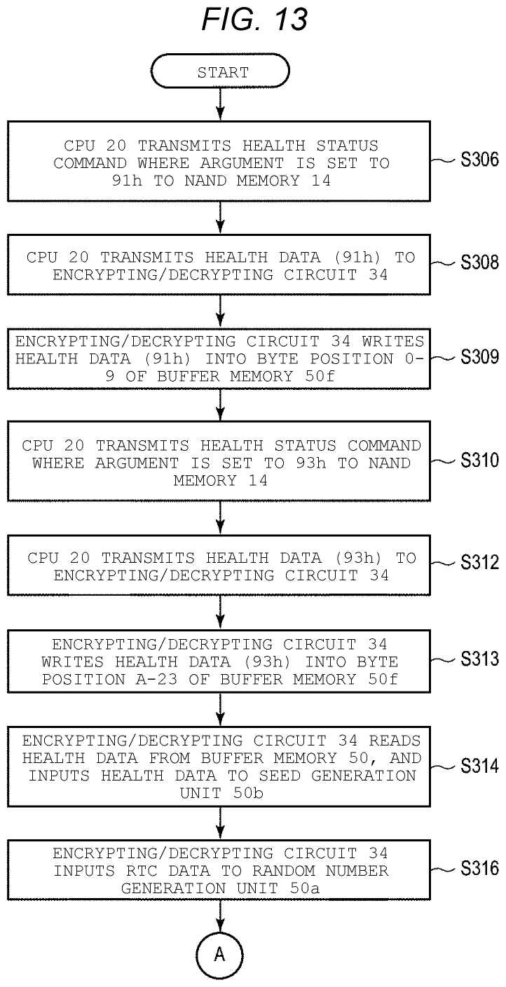

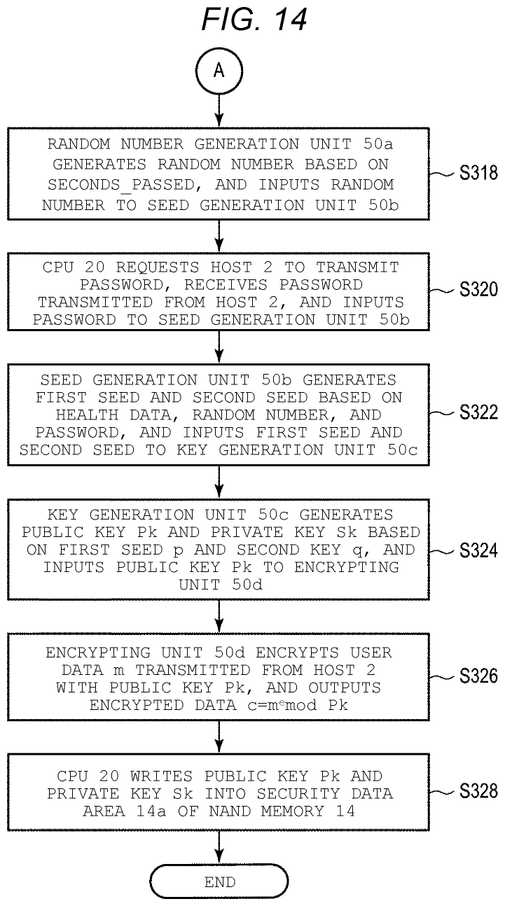

FIG. 13 is a flowchart illustrating a first half of a detailed example of the encrypting process of the encrypting/decrypting circuit 34 according to the first embodiment. FIG. 14 is a flowchart illustrating a second half of the detailed example of the encrypting process of the encrypting/decrypting circuit 34 according to the first embodiment.

The CPU 20 transmits a health status command where the argument is set to 91h to the NAND memory 14 (S306).

The NAND memory 14 transmits the health data (91h) back to the CPU 20.

The CPU 20 transmits the health data (91h) to the encrypting/decrypting circuit 34 (S308).

The encrypting/decrypting circuit 34 writes the health data (91h) into a byte position 0-9 of the buffer memory 50f (S309). The buffer memory 50f stores health data of 36 bytes as illustrated in FIGS. 9A to 9D.

The CPU 20 transmits a health status command where the argument is set to 93h to the NAND memory 14 (S310).

The NAND memory 14 transmits the health data (93h) back to the CPU 20.

The CPU 20 transmits the health data (93h) to the encrypting/decrypting circuit 34 (S312).

The encrypting/decrypting circuit 34 writes the health data (93h) into a byte position A-23 of the buffer memory 50f (S313).

The encrypting/decrypting circuit 34 reads health data of 36 bytes from the buffer memory 50f, and inputs the health data to the seed generation unit 50b (S314).

The RTC 28 transmits normal RTC data to the CPU 20. The CPU 20 transmits the normal RTC data to the encrypting/decrypting circuit 34.

The encrypting/decrypting circuit 34 inputs the RTC data transmitted from the CPU 20 to the random number generation unit 50a (S316).

The random number generation unit 50a generates random number based on SECONDS_PASSED (r7-r0) in the RTC data, and inputs the random number to the seed generation unit 50b (S318).

$$Random number = r {7}^{3} + r {6}^{2} + r {5}^{3} + r {4}^{3} + r {3}^{2} + r {2}^{4} + r {1}^{2} + r {0}^{3} \qquad Expression 1$$

The numerical values 2, 3, and 4 of the powers of data of the respective bytes are selected such that the number of digits in the random number is 8.

When SECONDS_PASSED (r7-r0) indicates “00 00 00 0E D7 60 B9 23” (hexadecimal number), the random number is obtained as follows.

$$Random number = 0 \times 0 {0}^{3} + 0 \times 0 {0}^{2} + 0 \times 0 {0}^{3} + 0 \times 0 {E}^{3} + 0 \times D {7}^{2} + 0 \times 6 {0}^{4} + 0 \times B {9}^{2} + 0 \times 2 {3}^{3} = 85060725 \qquad Expression 2$$

The random number of Expression 2 is a decimal number.

The CPU 20 requests the host 2 to transmit a password, receives the password transmitted from the host 2, and inputs the password to the seed generation unit 50b (S320). As in the second example of the write/read process illustrated in FIGS. 6 and 7, the password is not essential in the encrypting process.

The seed generation unit 50b generates a first seed and a second seed for key generation based on the health data of 36 bytes, the random number, and the password, and inputs the first seed and the second seed to the key generation unit 50c (S322).

Specifically, the seed generation unit 50b multiplies the health data by the random number by the password to acquire the product of 360 digits (19563 . . . 82436). The seed generation unit 50b decomposes the product of 360 digits into the product of 180 digits configured with configured with odd number digits and the product of 180 digits configured with even number digits. Assuming that the product is a numerical value 1956384713 (D9-DO) of 10 digits for simplification of the description, the product configured with odd number digits (D9, D7, D5, D3, D1) is 15341, and the product configured with even number digits (D8, D6, D4, D2, DO) is 96873.

The seed generation unit 50b includes a conversion unit that converts an input into a prime number. The seed generation unit 50b inputs the product of 180 digits configured with odd number digits to the conversion unit, and generates a first prime number p of 180 digits. The seed generation unit 50b inputs the product of 180 digits configured with even number digits to the conversion unit, and generates a second prime number q of 180 digits. The first prime number p is the first seed, and the second prime number q is the second seed.

The key generation unit 50c generates a public key Pk and a private key Sk based on the first seed p and the second seed q, and inputs the public key Pk to the encrypting unit 50d (S324). The public key Pk is p×q. The private key Sk is a natural number when the remainder obtained by dividing Sk×e by (p−1)×(q−1) is 1. Here, e represents a natural number relatively prime to (p−1)×(q−1). For example, when p=47 and q=71, the public key Pk is 3377. When e is, for example, 79, the private key Sk is 1019.

The encrypting unit 50d encrypts user data m transmitted from the host 2 with the public key Pk, and outputs the encrypted data c=me mod Pk (S326). The encrypted data is written into the user data area 14b after executing an error correcting coding process thereon with the ECC circuit (not illustrated).

The CPU 20 writes the public key Pk and the private key Sk into the security data area 14a of the NAND memory 14 (S328). Next, the encrypting process ends.

Next, key allocation will be described.

When the number of keys used by the encrypting/decrypting circuit 34 increases, the confidentiality of data increases, but the size of the security data area 14a where the public key and the private key are stored increases. Assuming that the size of the NAND memory 14 is fixed, when the number of keys increases, the size of the user data area 14b decreases, and the cost per bit of the data stored in the NAND memory 14 increases. The CPU 20 processes the user data in units of block data having a fixed size. An example of the size of the block data is 4 KB.

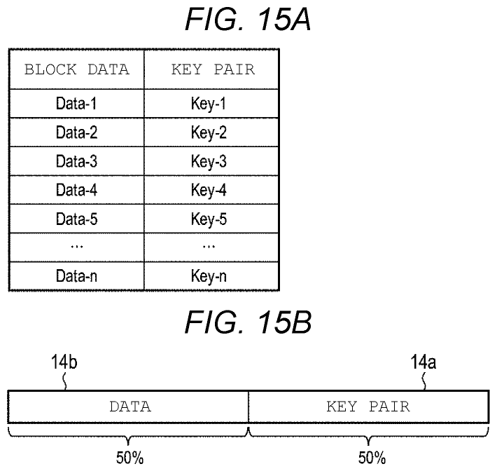

FIGS. 15A and 15B are diagrams illustrating a first example of key allocation in the memory system 4 according to the first embodiment. FIG. 15A illustrates an example of a key allocation table illustrating a key pair of a public key and a private key allocated to each block data of 4 KB. In the first example of key allocation, the CPU 20 allocates a first key pair (Key-1) to first block data (Data-1), and allocates a second key pair (Key-2) to second block data (Data-2). Hereinafter, likewise, the CPU 20 allocates an n-th key pair to n-th block data (Data-n). n represents a positive integer of 2 or more.

The CPU 20 writes the key allocation table into the buffer memory 50g. When the power of the memory system 4 is interrupted, the CPU 20 writes the key allocation table into the security data area 14a for nonvolatilization. The CPU 20 writes the key allocation table stored in the security data area 14a into the buffer memory 50g when the power of the memory system 4 is input.

In the first example of key allocation, the dedicated key pair is allocated to each of the block data. Therefore, the confidentiality of data is high.

When the same key pair is used for a long period of time, the private key is highly likely to be estimated. Therefore, the CPU 20 updates the key pair at a certain timing. Hereinafter, key update refers to update the public key and update of the private key. Before the key update, the CPU 20 reads data encrypted with a non-updated public key from the user data area 14b, and causes the encrypting/decrypting circuit 34 to decode the encrypted data with the private key. The CPU 20 causes the encrypting/decrypting circuit 34 to re-encode the user data obtained by decoding with the updated public key. The CPU 20 updates the encrypted data that is stored in the user data area 14b and is encrypted with the non-updated public key to the re-encrypted data. In the first example of key allocation, one key update operation only needs to update one piece of block data. Therefore, the key is simply updated with high speed.

It is assumed that the total size of write target data is 100 MB, the block size is 4 KB, and the size of each of a public key and a private key of one key pair is 4 KB. 1024 (=100 MB/4 KB) key pairs are allocated to data of 100 MB.

FIG. 15B is a diagram illustrating a size ratio between the user data area 14b and the security data area 14a where the key pairs are stored in the NAND memory 14. In the first example of key allocation, the sizes of the key pairs and the block data are the same, and one key pair is allocated to each of the block data. Therefore, the ratio of the security data area 14a in the NAND memory 14 is 50%. Therefore, the ratio of the user data area 14b where data is stored in the NAND memory 14 is 50%.

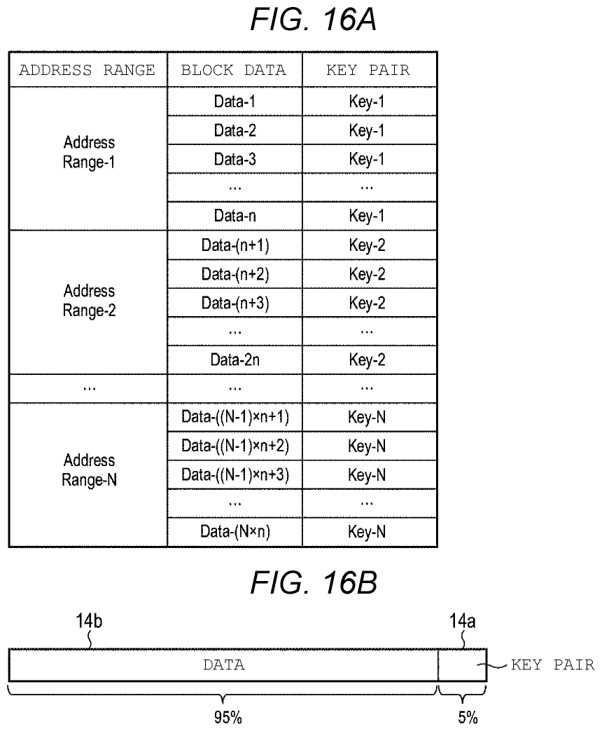

FIGS. 16A and 16B are diagrams illustrating a second example of key allocation in the memory system 4 according to the first embodiment. FIG. 16A illustrates an example of the key allocation table illustrating a key pair assigned to each of address ranges of the user data area 14b. A predetermined size of data, that is, a plurality of data corresponding to a plurality of code words are stored in one address range. For example, n pieces of block data of 4 KB is stored in an address range where data of 16 MB is stored, and one key pair of 4 KB is allocated to n pieces of block data.

In the second example of key allocation, the CPU 20 allocates a first key pair to n pieces of block data including first block data, second block data, . . . , and n-th block data stored in the first address range. The CPU 20 allocates a second key pair to n pieces of block data including (n+1)-th block data, (n+2)-th block data, . . . and 2n-th block data stored in a second address range. Hereinafter, likewise, the CPU 20 allocates an N-th key pair to n pieces of block data including ((N−1)×n+1)-th block data, ((N−1)×n+2)-th block data, . . . , and (N×n)-th block data stored in an N-th address range. N represents a positive integer of 2 or more.

FIG. 16B is a diagram illustrating a size ratio between the user data area 14b where data is stored and the security data area 14a where the key pairs are stored in the NAND memory 14. Assuming that the key pair size is 4 KB and the storage capacity of the NAND memory 14 is 64 GB, a storage area 14b of data is 61 GB, and a storage area 14a of the key pairs is 3 GB.

In the second example of key allocation, the ratio of the storage area 14a of the key pairs in the NAND memory 14 is less than that in the first example of key allocation, and the ratio of the storage area 14a of data in the NAND memory 14 is more than that in the first example of key allocation. Therefore, the cost per bit of data stored in the NAND memory 14 in the second example of key allocation is lower than that in the first example of key allocation. However, the update of one key also requires the update of data. The update of data requires the decoding of all the data stored in one address range, the re-encrypting of data obtained by decoding, the erasing of data, and the rewriting of the re-encrypted data. Therefore, in the second example of key allocation, the key update is more complicated than that in the first example of key allocation, and a longer period of time is required.

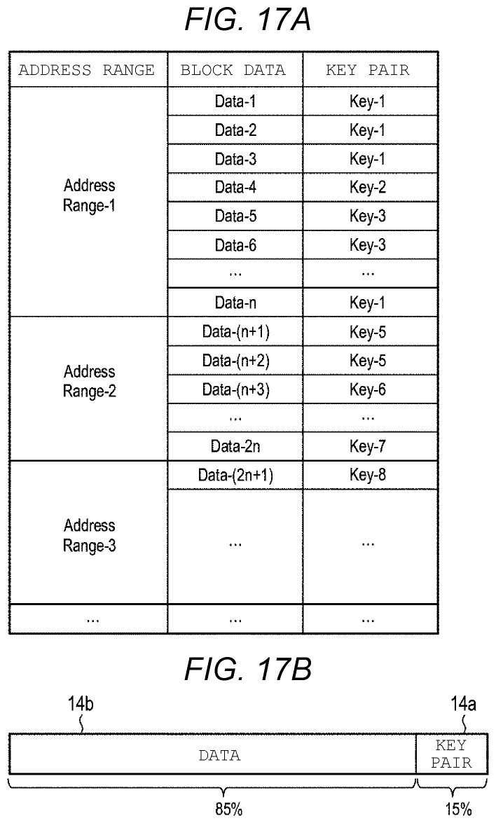

FIGS. 17A and 17B are diagrams illustrating a third example of key allocation in the memory system 4 according to the first embodiment. FIG. 17A illustrates an example of the key allocation table illustrating a plurality of key pairs assigned to each of address ranges of the user data area 14b. The upper limit number of key pairs allocated to one address range is limited. The upper limit number is, for example, 3.

In the third example of key allocation, the CPU 20 allocates any of first to third pairs to each of block data stored in the first address range. For example, the CPU 20 allocates the first key pair to first block data, second block data, and third block data, allocates the second key pair to fourth block data, allocates the third key pair to fifth block data and sixth block data, and allocates the first key pair to n-th block data.

The CPU 20 allocates a fifth key pair to the (n+1)-th block data and the (n+2)-th block data stored in the second address range, allocates a sixth key pair to (n+3)-th block data, and allocates a seventh key pair to 2n-th block data.

The CPU 20 allocates an eighth key pair to (2n+1)-th block data stored in a third address range.

FIG. 17B is a diagram illustrating a size ratio between the user data area 14b and the security data area 14a where the key pairs are stored in the NAND memory 14. Assuming that the key pair size is 4 KB and the storage capacity of the NAND memory 14 is 64 GB, a user data storage area 14b is 54.4 GB, and a storage area 14a of the key pairs is 96 GB.

In the third example of key allocation, the storage area of data in the NAND memory 14 is less than that in the second example of key allocation. However, the update of one key only needs to update a less number of data than the number of data stored in one address range. Therefore, the update of a key in the third example of key allocation is simpler than that in the second example of key allocation that requires the update of all the data stored in one address range, and only requires a short period of time. The NAND memory 14 deteriorates due to the write operation for updating data. Therefore, in the third example of key allocation, the NAND memory 14 is more likely to deteriorate than the second example of key allocation.

A key generation timing will be described. Hereinafter, the key generation includes new generation and update that requires update of data after the generation. The new generation does not require the update of data.

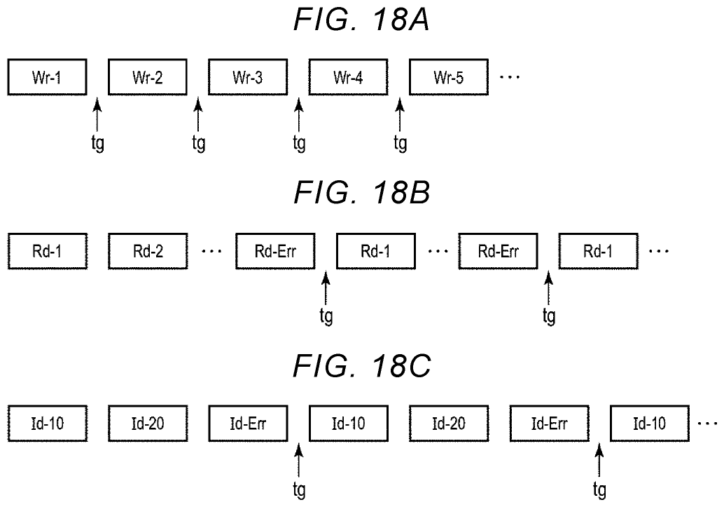

FIGS. 18A to 18C are diagrams illustrating three examples of a key generation timing in the memory system 4 according to the first embodiment. In the description of FIGS. 18A to 18C, the use of the third example of key allocation is assumed regarding the key allocation. However, the first example and the second example may be used instead of the third example of key allocation.

FIG. 18A is a diagram illustrating the first example of the key generation timing. When the host 2 continuously transmits a plurality of write requests Wr-1, Wr-2, Wr-3, Wr-4, Wr-5, . . . , the first example of the key generation timing μg is after the reception of each of the write requests.

After the reception of the write request, the CPU 20 generates a key pair of a public key and a private key for each of block data configuring user data in the write request. When only the upper limit number or less of key pairs are allocated to an address range where the user data is stored in the write request, the CPU 20 allocates a newly generated key pair to block data in the write request (new generation). When the upper limit number of keys are already allocated to the address range where the user data is stored in the write request, the CPU 20 updates any of the keys already allocated to the address range to the newly generated key. The determination of an update target key will be described below.

FIG. 18B is a diagram illustrating a second example of the key generation timing. The second example of the key generation timing tg is an error detection timing during the host read operation. The host 2 repeatedly transmits a plurality of read requests Rd-1, Rd-2, and . . .

When the read request is received, the CPU 20 reads user data of a size designated by the data size from the start address, checks ECC of the read data, and determines whether the read data includes correctable error. When the read data includes correctable error (Rd-Err), the CPU 20 corrects the error and transmits the corrected data to the encrypting/decrypting circuit 34. The CPU 20 generates a key pair and transmits the key pair to the encrypting/decrypting circuit 34. The encrypting/decrypting circuit 34 decrypts the corrected data. The CPU 20 transmits the user data obtained by decoding to the host 2. The CPU 20 updates the key pair allocated to the read data to the newly generated key pair.

FIG. 18C is a diagram illustrating a third example of the key generation timing. The third example of the key generation timing tg is an error detection timing during a patrol read operation. The patrol read operation refers to an operation in which, in order to detect a block where error increases, the controller 12 generates a read request irrespective of a read request from the host 2, transmits the generated read request to the NAND memory 14, reads data from a predetermined address of the NAND memory 14, and checks the degree to which error is present in the read data. The controller 12 executes the patrol read operation in an idle period where a write request or a read request from the host 2 is not received. Id-10 and Id-20 represent patrol read periods (periods where error is not detected by the patrol read operation) of 10 minutes and 20 minutes, respectively.

As in the time where a read request is received from the host, during the patrol read operation, the CPU 20 reads data from the user data area 14b, executes an error detection and correction process on the read data, and determines whether error is correctable. When error is correctable (Id-Err), the CPU 20 obtains the error-corrected data.

The CPU 20 inputs the error-corrected data to the encrypting/decrypting circuit 34 as the encrypted data. The encrypting/decrypting circuit 34 decrypts the input encrypted data. That is, the CPU 20 decrypts data based on the data read from the NAND memory 14 during the patrol read operation.

The CPU 20 generates a key pair and transmits the key pair to the encrypting/decrypting circuit 34. The encrypting/decrypting circuit 34 encrypts the decrypted data. The CPU 20 updates the non-error-corrected data stored in the user data area 14b to the encrypted error-corrected data. The write operation for update will be referred to as “refresh write operation”.

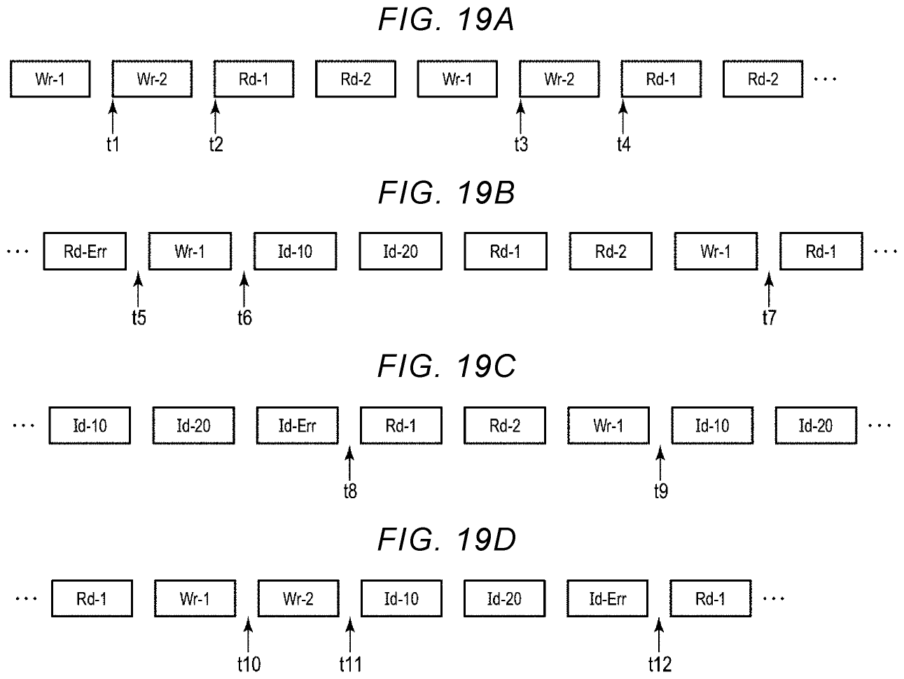

FIGS. 19A to 19D are diagrams illustrating examples of processes of generating keys in accordance with the first example, the second example, and the third example of the key generation timing in the memory system 4 according to the first embodiment. In the description of FIGS. 19A to 19D, the use of the third example of key allocation is assumed regarding the key allocation. However, the first example and the second example may be used instead of the third example of key allocation. FIG. 19A illustrates a process of a certain period of time, FIG. 19B illustrates a process of a certain period of time following FIG. 19A, FIG. 19C illustrates a process of a certain period of time following FIG. 19B, and FIG. 19D illustrates a process of a certain period of time following FIG. 19C.

When a write request Wr-1 for an address range 1 is received from the host 2 (timing t1), the CPU 20 generates a new key pair. At timing t1, it is assumed that only an upper limit number or less of key pairs are allocated to the address range 1. Therefore, the CPU 20 allocates the newly generated key pair to block data in the write request. The CPU 20 causes the encrypting/decrypting circuit 34 to encrypt the block data in the write request with the generated public key.

When a write request Wr-2 for an address range 2 is received from the host 2 (timing t2), the CPU 20 generates a new key pair. At timing t2, it is assumed that only an upper limit number or less of key pairs are allocated to the address range 2. Therefore, the CPU 20 allocates the newly generated key pair to block data in the write request. The CPU 20 causes the encrypting/decrypting circuit 34 to encrypt the user data in the write request with the generated public key.

When a new write request Wr-1 is received after receiving two read requests Rd-1 and Rd-2 (timing t3), the CPU 20 generates a new key pair or updates the key pair stored in the security data area 14a.

When a write request Wr-2 for a certain address range is received in a state where the upper limit number of key pairs are already allocated to the certain address range (timing t4), the CPU 20 updates any key pair among the upper limit number of key pairs allocated to the certain address range.

When error Rd-Err of read data is detected after receiving a plurality of read requests Rd-1, Rd-2, . . . from the host 2 (timing t5), the CPU 20 updates the key pair.

When a new write request Wr-1 is received after detecting (Rd-Err) the error of read data (timing t6), the CPU 20 generates a key pair or updates the key pair.

When two read requests Rd-1 and Rd-2 and a write request Wr-1 are received after the patrol read period Id-10 of 10 minutes and the patrol read period Id-20 of 20 minutes (timing t7), the CPU 20 generates a key pair or updates the key pair.

When error Id-Err is detected by the patrol read operation after the read request Rd-1, the patrol read period Id-10 of 10 minutes, and the patrol read period Id-20 of 20 minutes (timing t8), the CPU 20 updates the key pair.

When a write request Wr-1 is received after receiving two read requests Rd-1 and Rd-2 (timing t9), the CPU 20 generates a key pair or updates the key pair.

When a read request Rd-1 and a write request Wr-1 are received after the patrol read period Id-10 of 10 minutes and the patrol read period Id-20 of 20 minutes (timing t10), the controller 12 generates a key pair or updates the key pair.

When a write request Wr-2 for a certain address range is received in a state where the upper limit number of key pairs are already allocated to the certain address range (timing t11), the CPU 20 updates any key pair among the upper limit number of key pairs allocated to the certain address range.

When error Id-Err is detected by the patrol read operation after the patrol read period Id-10 of 10 minutes and the patrol read period Id-20 of 20 minutes (timing t12), the CPU 20 updates the key pair.

The determination of an update target key pair during the key update will be described.

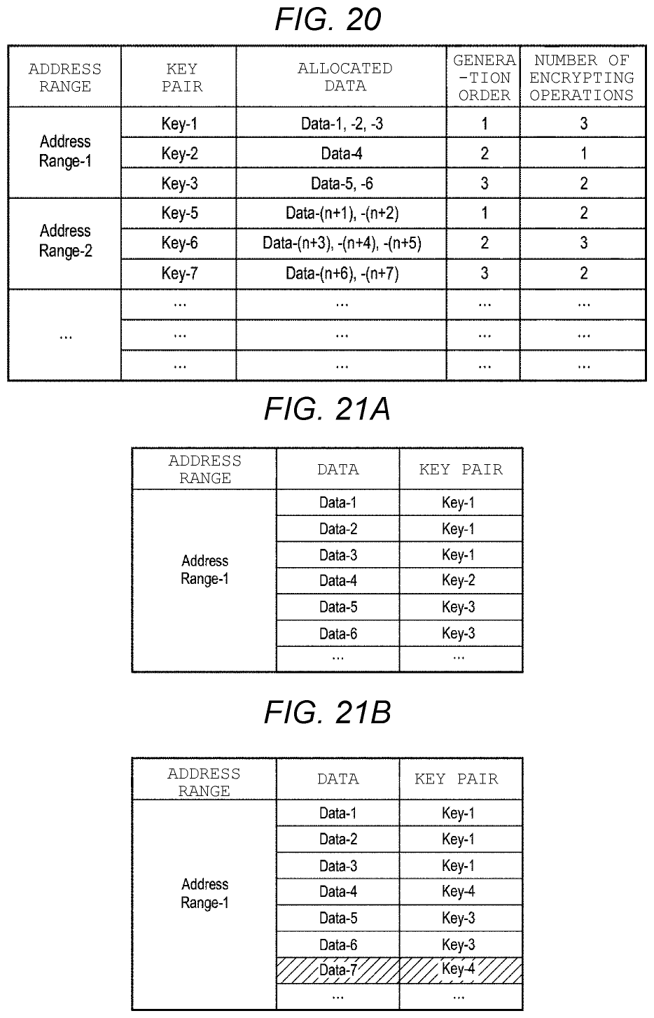

FIG. 20 is a diagram illustrating an example of a key update table used for determining the update target key in the third example of key allocation in the memory system 4 according to the first embodiment. The key update table is stored in the buffer memory 50g. When the power of the memory system 4 is interrupted, the CPU 20 writes the key update table into the security data area 14a for nonvolatilization. When the power of the memory system 4 is input, the CPU 20 writes the key update table stored in the security data area 14a into the buffer memory 50g.

The CPU 20 determines the update target key pair with reference to the key update table. The key update table includes an address range, a key pair, allocated data, a generation order, and the number of encrypting operations. The upper limit number of key pairs that can be allocated to each of address ranges is, for example, 3. The allocated data indicates block data to which the key pair is allocated. The generation order indicates the order of key generation periods, “1” indicates that the key generation period is the earliest or that the elapsed time from the generation is the longest, and “3” indicates that the key generation period is currently the latest or that the elapsed time from the generation is the shortest. The number of encrypting operations indicates the number of block data allocated to the key, that is, the size.

As illustrated in FIGS. 17A and 17B, the first key pair, the second key pair, and the third key pair are allocated to the first address range. The three key pairs are generated in the order of the first key pair, the second key pair, and the third key pair.

Regarding the first key pair, the generation period is the earliest, the generation order is “1”, and the first key pair is allocated to the first block data, the second block data, and the third block data. Therefore, the number of encrypting operations is “3”. Regarding the second key pair, the generation period is the second earliest, the generation order is “2”, and the second key pair is allocated to the fourth block data. Therefore, the number of encrypting operations is “1”. Regarding the third key pair, the generation period is the latest, the generation order is “3”, and the third key pair is allocated to the fifth block data and the sixth block data. Therefore, the number of encrypting operations is “2”.

As illustrated in FIGS. 17A and 17B, the fifth key pair, the sixth key pair, and the seventh key pair are allocated to the second address range. The three key pairs are generated in the order of the fifth key pair, the sixth key pair, and the seventh key pair.

Regarding the fifth key pair, the generation period is the earliest, the generation order is “1”, and the fifth key pair is allocated to the (n+1)-th block data and the (n+2)-th block data). Therefore, the number of encrypting operations is “2”.

Regarding the sixth key pair, the generation period is the second earliest, the generation order is “2”, and the sixth key pair is allocated to the (n+3)-th block data, the (n+4)-th block data, and the (n+5)-th block data. Therefore, the number of encrypting operations is “3”.

Regarding the seventh key pair, the generation period is the latest, the generation order is “3”, and the seventh key pair is allocated to the (n+6)-th block data and the (n+7)-th block data). Therefore, the number of encrypting operations is “2”.

When a new key pair is generated for block data in an address range to which the upper limit number of key pairs are already allocated, the CPU 20 sets a key pair where the number of encrypting operations is the smallest as an update target. The reason for this is that, since the key update is accompanied by date update, it is desirable to reduce the size of data to be updated. The size of data to which the key pair where the number of encrypting operations is the smallest is updated is less than the size of data to which another key pair is allocated. As a result, the write amount of data accompanied by the update is the smallest, and the effect of the key update on the lifetime of the NAND memory 14 can be minimized.

When a plurality of key pairs where the number of encrypting operations is the smallest are present, the CPU 20 sets a key pair where the numerical value of the generation order is the smallest as an update target. The reason for this is presumed to be that, since the key pair where the numerical value of the generation order is the smallest has the earliest generation period, the key pair is used for the longest period of time and is highly likely to be estimated. However, when a plurality of key pairs where the number of encrypting operations is the smallest are present, the CPU 20 may set a key pair where the generation period is the latest or any key pair as an update target.

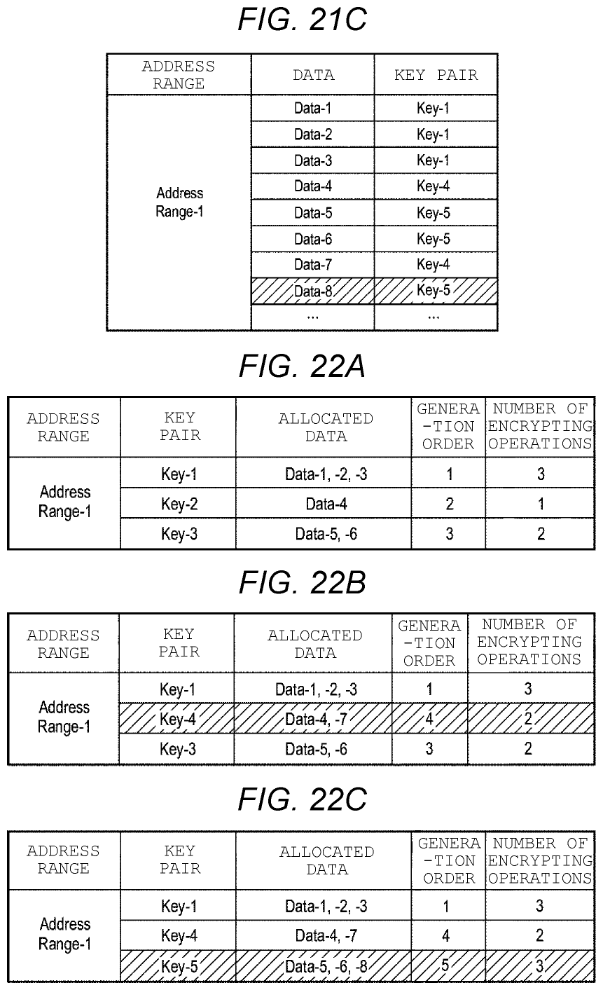

FIGS. 21A to 21C and FIGS. 22A to 22C are diagrams illustrating examples of the key update caused by new generation of a key. FIG. 21A illustrates a part of the first address range of the key allocation table illustrated in FIGS. 17A and 17B. FIG. 22A illustrates a part of the first address range of the key update table illustrated in FIG. 20.

When a write request to write seventh block data to a certain address in the first address range is received from the host 2, the CPU 20 generates a fourth key pair. When the fourth key pair is generated, the CPU 20 allocates the fourth key pair to the seventh block data (FIG. 21B).

The CPU 20 sets the second key pair where the number of encrypting operations in the key update table illustrated in FIG. 22A is the smallest as an update target. Before updating the second key pair to the fourth key pair, the CPU 20 decrypts the fourth block data to which the second key pair is allocated with the private key of the second key pair, and re-encrypts a plaintext obtained by decoding with the public key of the fourth key pair. The CPU 20 encrypts the seventh block data with the public key of the fourth key pair. The CPU 20 writes the fourth block data (re-encrypted data) and the seventh block data (encrypted data) into the first address range of the user data area 14b. Next, the CPU 20 updates the second key pair to the fourth key pair (FIG. 22B). The generation order of the fourth key pair is “4”. The fourth key pair is allocated to the fourth block data and the seventh block data. The number of encrypting operations of the fourth key pair is “2”.

When the controller 12 receives a write request to write eighth block data to a certain address in the first address range from the host 2, the CPU 20 generates a fifth key pair. When the fifth key pair is generated, the CPU 20 allocates the fifth key pair to the eighth block data (FIG. 21C).

The CPU 20 sets the fourth key pair and the third key pair where the number of encrypting operations in the key update table illustrated in FIG. 22B is the smallest as update target candidates. The CPU 20 sets the third key pair where the numerical value of the generation order is smaller, that is, the generation period is earlier among the fourth key pair and the third key pair as an update target. Before updating the third key pair to the fifth key pair, the CPU 20 decrypts the fifth block data and the sixth block data to which the third key pair is allocated with the private key of the third key pair, and re-encrypts a plaintext obtained by decoding with the public key of the fifth key pair. The CPU 20 encrypts the eighth block data with the public key of the fifth key pair. The CPU 20 writes the fifth block data (encrypted data), the sixth block data (encrypted data), and the eighth block data (encrypted data) into the first address range of the user data area 14b. Next, the CPU 20 updates the third key pair to the fifth key pair (FIG. 22C). The generation order of the fifth key pair is “5”. The fifth key pair is allocated to the fifth block data, the sixth block data, and the seventh block data. The number of encrypting operations of the fifth key pair is “3”.

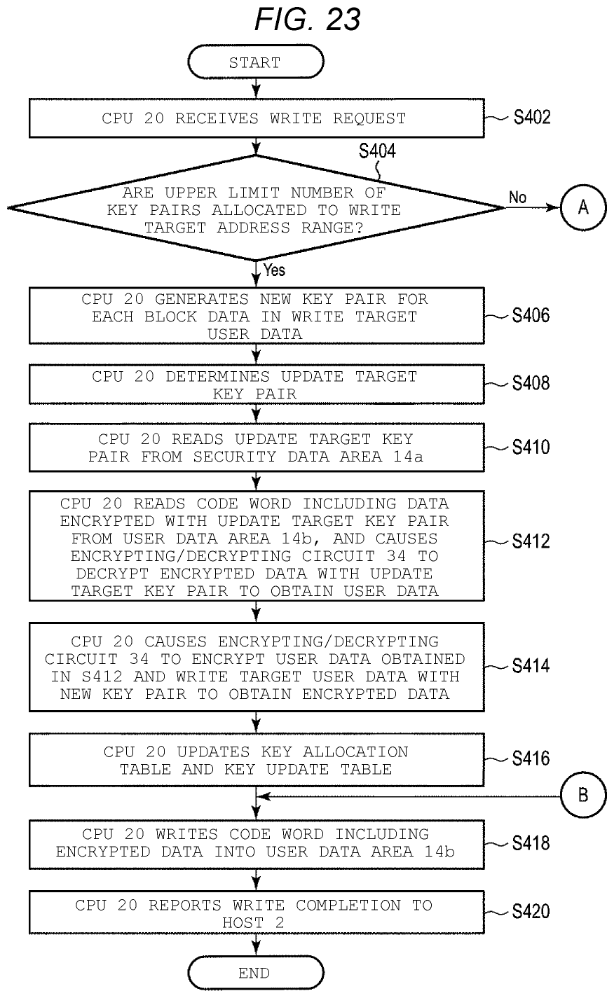

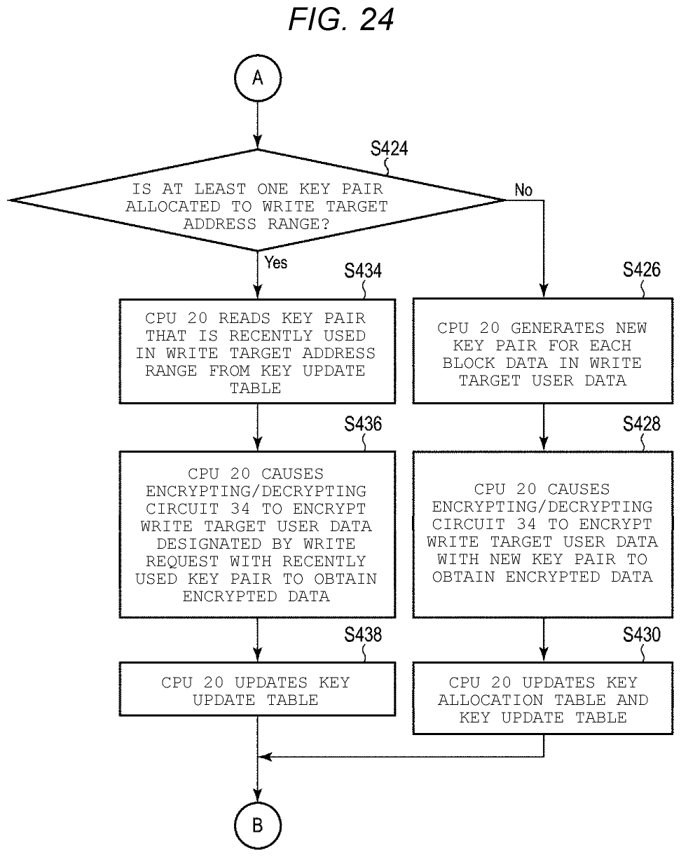

FIGS. 23 and 24 are flowcharts illustrating an example of the write operation in the memory system 4 according to the first embodiment.

When a write request is received (S402), the CPU 20 refers to the key allocation table (FIGS. 17A and 17B) stored in the buffer memory 50g to determine whether the upper limit number of key pairs are allocated to a write target address range including an address designated by the write request (S404).

When the upper limit number of key pairs are allocated to the write target address range (S404 Yes), the CPU 20 generates a new key pair in each of block data in the write target user data designated by the write request (S406).

The CPU 20 refers to the key update table (FIG. 20) stored in the buffer memory 50g to determine an update target key pair (S408).

The CPU 20 reads the update target key pair from the security data area 14a (S410).

The CPU 20 reads a code word including the data encrypted with the update target key pair from the user data area 14b, and causes the encrypting/decrypting circuit 34 to decode the encrypted data with the update target key pair to obtain user data (S412).

The CPU 20 causes the encrypting/decrypting circuit 34 to encrypt the user data obtained in S412 and the write target user data with the new key pair to obtain encrypted data (S414).

The CPU 20 updates the key allocation table (FIGS. 17A and 17B) and the key update table (FIG. 20) (S416).

The CPU 20 writes the code word including the encrypted data into the user data area 14b (S418). The CPU 20 may execute the update of the tables (S416) and the write operation (S418) of the code word in the reverse order.

Next, the CPU 20 reports write completion to the host 2 (S420), and ends the write operation.

When the number of key pairs allocated to the write target address range is the upper limit number or less (S404 No), the CPU 20 determines whether at least one key pair is allocated to the write target address range (S424).

When even one key pair is not allocated to the write target address range (S424 No), the CPU 20 generates a new key pair for each of block data in the write target (S426).

The CPU 20 causes the encrypting/decrypting circuit 34 to encrypt the write target user data with the new key pair to obtain encrypted data (S428).

The CPU 20 updates the key allocation table (FIGS. 17A and 17B) and the key update table (FIG. 20) (S430).

The CPU 20 writes the code word including the encrypted data into the user data area 14b (S418). The CPU 20 may execute the update of the tables (S430) and the write operation (S418) of the code word in the reverse order.

Next, the controller 12 reports write completion to the host 2 (S420), and ends the write operation.

When at least one key pair is allocated to the write target address range (S424 Yes), the CPU 20 reads a key pair that is recently used in the write target address range from the key update table (FIG. 20) (S434).

The CPU 20 causes the encrypting/decrypting circuit 34 to encrypt write target user data designated by the write request with the recently used key pair to obtain encrypted data (S436).

The CPU 20 updates the key update table (FIG. 20) (S438).

The CPU 20 writes the code word including the encrypted data into the user data area 14b (S418). The CPU 20 may execute the rewrite operation of the tables (S438) and the write operation (S418) of the code word in the reverse order.

Next, the CPU 20 reports write completion to the host 2 (S420), and ends the write operation.

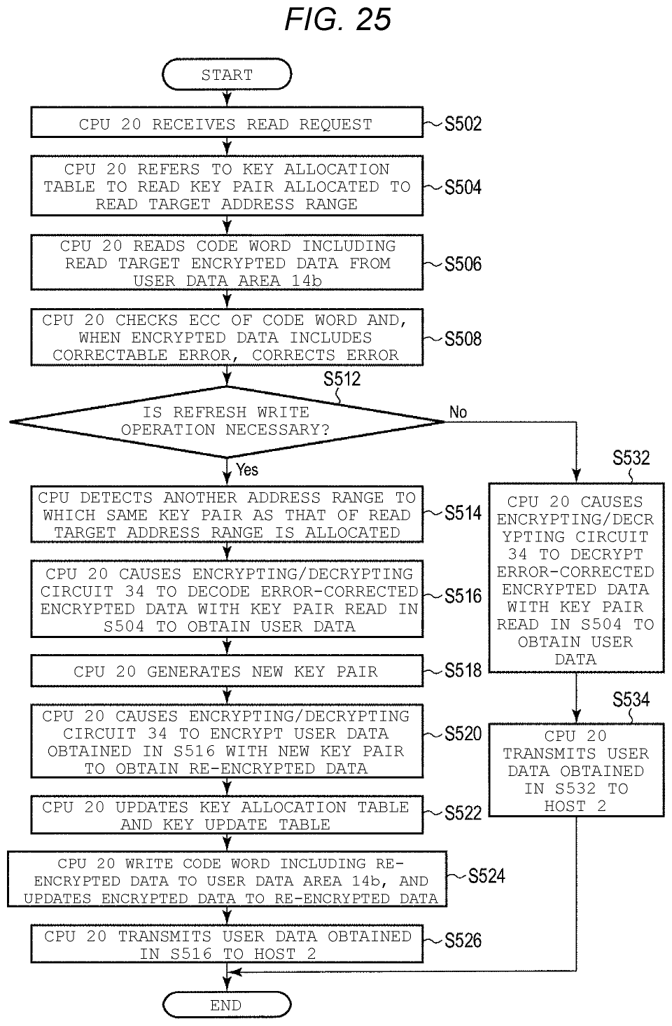

FIG. 25 is a flowchart illustrating an example of the read operation in the memory system 4 according to the first embodiment.

When a read request is received (S502), the CPU 20 refers to the key allocation table (FIGS. 17A and 17B) stored in the buffer memory 50g to read a key pair allocated to a read target address range including an address designated by the read request (S504).

The CPU 20 reads a code word including the read target data (encrypted data) designated by the read request from the user data area 14b (S506).

The CPU 20 checks ECC of the read code word and, when the encrypted data includes correctable error, corrects the error (S508).

When the error is corrected, the CPU 20 executes the refresh write operation. The CPU 20 determines whether the error is corrected, that is, the refresh write operation of the NAND memory 14 is necessary (S512).

When the refresh write operation is necessary (S512 Yes), the CPU 20 detects an address range having the same size as the read target address range (S514).

The CPU 20 causes the encrypting/decrypting circuit 34 to decode the error-corrected encrypted data with the key pair read in S504 to obtain user data (S516).

The CPU 20 generates a new key pair (S518).

The CPU 20 causes the encrypting/decrypting circuit 34 to encrypt the user data obtained in S516 with the new key pair to obtain re-encrypted data (S520).

The CPU 20 updates the key allocation table (FIGS. 17A and 17B) and the key update table (FIG. 20) (S522).

The CPU 20 writes a code word including the re-encrypted data into the user data area 14b, and updates the encrypted data to the re-encrypted data (S524).

Next, the CPU 20 transmits the user data obtained in S516 to the host 2 (S526), and ends the read operation.

When the refresh write operation is not necessary (S512 No), the CPU 20 causes the encrypting/decrypting circuit 34 to decode the error-corrected encrypted data with the key pair read in S504 to obtain user data (S532).

Next, the CPU 20 transmits the user data obtained in S532 to the host 2 (S534), and ends the read operation.

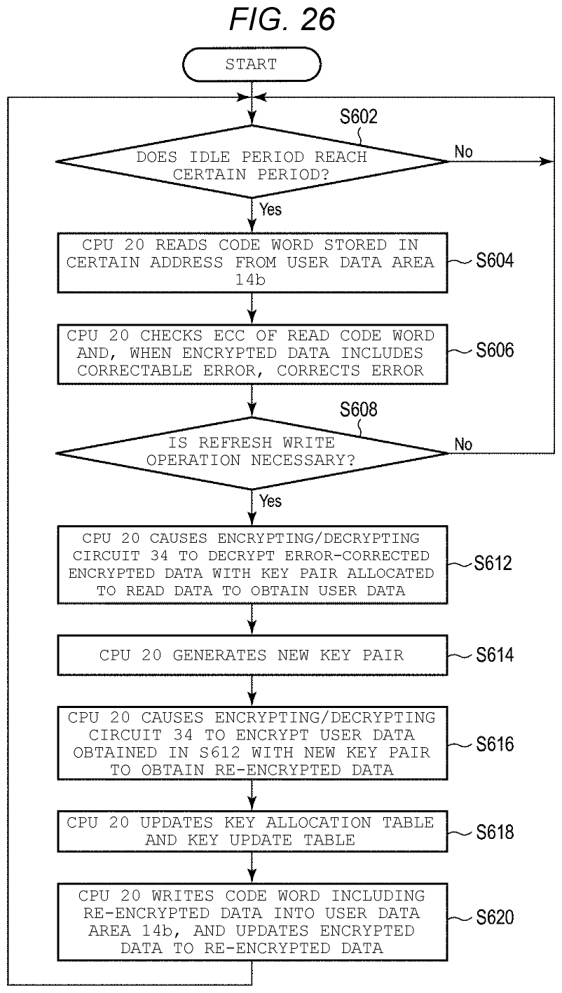

FIG. 26 is a flowchart illustrating an example of the patrol read operation in the memory system 4 according to the first embodiment.

The CPU 20 determines whether the idle period where a write request or a read request is not received from the host 2 reaches a certain period (S602).

When the idle period reaches the certain period (S602 Yes), the CPU 20 reads a code word including encrypted data stored in a certain address from the user data area 14b (S604).

The CPU 20 checks ECC of the read code word and, error, when the encrypted data includes correctable corrects the error (S606).

The CPU 20 determines whether the error is corrected, that is, the refresh write operation of the NAND memory 14 is necessary (S608).

When the refresh write operation is necessary (S608 Yes), the CPU 20 causes the encrypting/decrypting circuit 34 to decode the error-corrected encrypted data with the key pair allocated to the read data to obtain user data (S612).

The CPU 20 generates a new key pair (S614).

The CPU 20 causes the encrypting/decrypting circuit 34 to encrypt the user data obtained in S612 with the new key pair to obtain re-encrypted data (S616).

The CPU 20 updates the key allocation table (FIGS. 17A and 17B) and the key update table (FIG. 20) (S618).

The CPU 20 writes a code word including the re-encrypted data into the user data area 14b, and updates the encrypted data to the re-encrypted data (S620). Next, the CPU 20 determines whether the idle period reaches a certain period (S602).

When the refresh write operation is not necessary (S608 No), the CPU 20 determines whether the idle period reaches a certain period (S602).

When data written in the NAND memory 14 is received from the host 2, the memory system 4 according to the embodiment generates a key. The memory system 4 generates a key based on the RTC data output from the RTC 28 and the health data indicating the deterioration state of the NAND memory 14. The memory system 4 causes the encrypting/decrypting circuit 34 to encrypt data with the key, and writes a code word including the encrypted data and the key into the NAND memory 14. The NAND memory 14 includes a security data area 14a and a user data area 14b. The host 2 is accessible to the user data area 14b but is not accessible to the security data area 14a. The memory system 4 writes the encrypted data into the user data area 14b, and writes the key into the security data area 14a.

The time data and the health data based on which the key is generated change over time. Therefore, it is difficult for a third person to estimate the key. Therefore, the third person cannot decode encrypted data.

The storage area of the NAND memory 14 is divided into a plurality of address ranges. Code words corresponding to a plurality of data blocks are stored in the address ranges, respectively. A key is allocated to each of the data blocks. In order to reduce the storage capacity of the keys, the memory system 4 allocates only a predetermined number of keys to each of the address ranges, and allocates the same key to a plurality of data blocks.

The memory system 4 detects error during the read operation. When correctable error is detected, the memory system 4 corrects the error and executes the refresh write operation. Even when the refresh write operation is executed, the memory system 4 generates a key.

When a key is generated in a state where a predetermined number of keys are already allocated to a certain address range, the memory system 4 erases any of the predetermined number of keys and allocates a newly generated key to the certain address range instead of the erased key. Before erasing the already allocated key, the memory system 4 decrypts data encrypted with the key that is scheduled to be erased to obtain a plaintext, and re-encrypts the plaintext with a newly generated key. The memory system 4 erases encrypted data and writes the encrypted data into an address where the encrypted data is stored to update the encrypted data to the re-encrypted data.

The key update requires only the update of a code word in a certain address range, and the update of all the code words stored in the NAND memory 14 is not necessary. Therefore, the key update is completed in a short period of time, and the deterioration of the NAND memory 14 is small.

Further, the key to be updated is selected such that the amount of data to be re-encrypted is minimized. Therefore, the key update time is short, and the degree of deterioration of the NAND memory 14 is also small.

While certain embodiments have been described, these embodiments have been presented by way of example only, and are not intended to limit the scope of the disclosure. Indeed, the novel embodiments described herein may be embodied in a variety of other forms; furthermore, various omissions, substitutions, and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A memory system comprising:
a nonvolatile memory; and
a controller configured to:
generate an encryption key using health data indicating a deterioration state of the nonvolatile memory and time data;
encrypt data with the generated encryption key; and
write the encrypted data into the nonvolatile memory.

2. The memory system according to claim 1, wherein the time data includes an absolute time output from a real-time clock or a relative time from a certain reference time output from the real-time clock.

3. The memory system according to claim 1, wherein the health data includes a total size of data that has been written into the nonvolatile memory or a total size of data that has been read from the nonvolatile memory.

4. The memory system according to claim 1, wherein the health data includes a number of erase operations that has been performed with respect to the nonvolatile memory.

5. The memory system according to claim 4, wherein
the nonvolatile memory includes a memory cell array including a plurality of blocks, and
the health data includes a minimum value, a maximum value, and an average value among numbers of erase operations that have been performed with respect to the plurality of blocks, respectively.

6. The memory system according to claim 1, wherein the controller is configured to:
generate a random number from the time data;
generate one or more seeds from the health data and the random number; and
generate the encryption key from the one or more seeds.

7. The memory system according to claim 1, wherein
the nonvolatile memory includes a storage area that is divided into a plurality of address ranges, and
the controller is configured to generate one or more encryption keys for each of the plurality of address ranges.

8. The memory system according to claim 7, wherein the controller is configured to:
generate up to a predetermined number of encryption keys for each of the plurality of address ranges, and
when data is written into one of the address ranges for which the predetermined number of encryption keys have been generated, update a first encryption key among the predetermined number of encryption keys to a second encryption key.

9. The memory system according to claim 8, wherein
when the first encryption key is updated to the second encryption key, the controller:
reads data stored at the one of the address ranges of the nonvolatile memory and decrypts the read data using the first encryption key; and
encrypts the decrypted data using the second encryption key and writes the data encrypted with the second encryption key at the one of the address ranges of the nonvolatile memory.

10. The memory system according to claim 8, wherein the controller is configured to:
track a number of times encryption has been performed with respect to each of the encryption keys generated for the one of the address ranges; and
select, as the first encryption key, one of the encryption keys generated for the one of the address ranges with which encryption has been performed a fewest number of times.

11. The memory system according to claim 10, wherein the controller is configured to:
track an order of key generation with respect to the encryption keys generated for the one of the address ranges; and
when there are two or more encryption keys that have been generated for the one of the address ranges and with which encryption has been performed a fewest number of times, select, as the first encryption key, one of the two or more encryption keys corresponding to a latest one in the order.

12. The memory system according to claim 1, wherein
the controller performs the generation of the encryption key in response to a write request received from a host, and
the data encrypted using the encryption key is data corresponding to the write request.

13. The memory system according to claim 1, wherein
the controller is configured to perform reading of data from the nonvolatile memory, error detection and correction of the read data, and decryption of error-corrected data,
the controller performs the generation of the encryption key when the error correction is performed, and
the data encrypted using the encryption key is the data that has been error-corrected and decrypted.

14. The memory system according to claim 13, wherein the controller performs the reading when a predetermined amount of time has elapsed from a last access from a host.

15. The memory system according to claim 1, wherein
the controller is configured to perform reading of data from an address range of the nonvolatile memory, error detection and correction of the read data, and decryption of error-corrected data,
the controller performs the generation of the encryption key when the error correction is performed, and
the data encrypted using the encryption key corresponds to another data stored in the address range.

16. The memory system according to claim 15, wherein the controller performs the reading in response to a read request received from a host.

17. A method of controlling a nonvolatile memory, the method comprising:
reading health data indicating a deterioration state of the nonvolatile memory;
generating an encryption key using the read health data and time data;
encrypting data with the generated encryption key; and
writing the encrypted data into the nonvolatile memory.

18. The method according to claim 17, wherein the time data includes an absolute time output from a real-time clock or a relative time from a certain reference time output from the real-time clock.

19. The method according to claim 17, wherein the health data includes a total size of data that has been written into the nonvolatile memory or a total size of data that has been read from the nonvolatile memory.

20. The method according to claim 17, wherein the health data includes a number of erase operations that has been performed with respect to the nonvolatile memory.
